(19) United States
(12) Patent Application Publication
(10) Pub. No.: US 2024/0199666 A1
(43) Pub. Date: Jun. 20, 2024

(54) CYCLIC METAL PALLADIUM DIMER, AND PREPARATION METHOD AND USE THEREOF

(71) Applicant: GUANGXI MINZU UNIVERSITY, Nanning City (CN)

(72) Inventors: Yuzhen ZHANG, Nanning City (CN); Lige QIAO, Nanning City (CN); Xiangjun KONG, Nanning City (CN); Chuanli NIE, Nanning City (CN); Yunjun SHEN, Nanning City (CN)

(21) Appl. No.: 18/224,256

(22) Filed: Jul. 20, 2023

(30) Foreign Application Priority Data
Dec. 1, 2022 (CN) 202211531618.1

(51) Int. Cl. C07F 15/00

(52) U.S. Cl. CPC C07F 15/006; C07F 15/0066

(57) ABSTRACT

The present disclosure provides a cyclic metal palladium dimer, and a preparation method and use thereof, and belongs to the technical field of photoelectric materials. In the present disclosure, the cyclic metal palladium dimer can be used as a novel phosphorescent light-emitting material for organic light-emitting diodes (OLEDs), thus solving the problem of insufficient existing phosphorescent materials. Moreover, this dimer provides a new idea for the use of Pd metal in the structural design of phosphorescent materials.

### CROSS REFERENCE TO RELATED APPLICATION

This patent application claims the benefit and priority of Chinese Patent Application No. 202211531618.1, filed with the China National Intellectual Property Administration on Dec. 1, 2022, the disclosure of which is incorporated by reference herein in its entirety as part of the present application.

### TECHNICAL FIELD

The present disclosure relates to the technical field of photoelectric materials, in particular to a cyclic metal palladium dimer, and a preparation method and use thereof.

### BACKGROUND

Organic light-emitting diodes (OLEDs) are a type of LEDs that use organic compounds as a material for a light-emitting layer. The OLEDs have received extensive attention due to rapid response, thinness, flexibility, and excellent light quality. To improve an electroluminescence efficiency of the OLEDs, various fluorescence and phosphorescence-based emissive materials have been developed. Phosphorescent materials can simultaneously utilize singlet and triplet excitons, enabling an upper limit of a quantum efficiency within a device to reach 100%. However, traditional fluorescent materials can only achieve an upper limit of 25% of the quantum efficiency within the device. The light color of phosphorescent materials can be regulated by molecular design over the entire visible range. Therefore, phosphorescent organic light-emitting diodes (PHOLEDs) have the advantage of simultaneously achieving high luminous efficiency and color purity. However, currently the phosphorescent materials show insufficient development and limited types.

### SUMMARY

An objective of the present disclosure is to provide a cyclic metal palladium dimer, and a preparation method and use thereof. In the present disclosure, the cyclic metal palladium dimer can be used as a novel phosphorescent light-emitting material for organic light-emitting diodes (OLEDs), thus solving the problem of insufficient existing phosphorescent materials. Moreover, this dimer provides a new idea for the use of Pd metal in the structural design of phosphorescent materials.

To achieve the above objective, the present disclosure provides the following technical solutions:

The present disclosure provides a cyclic metal palladium dimer, having a structure shown in any one of (I) to (VI):

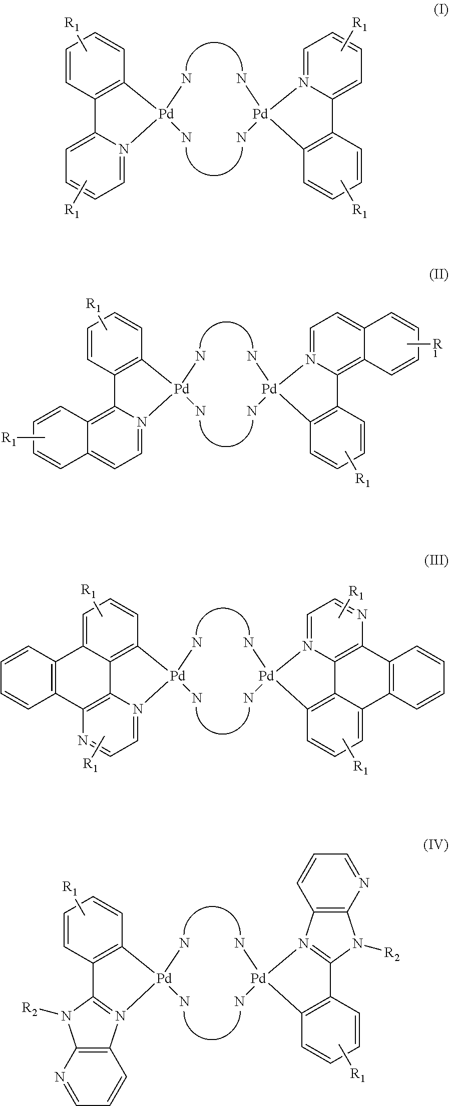

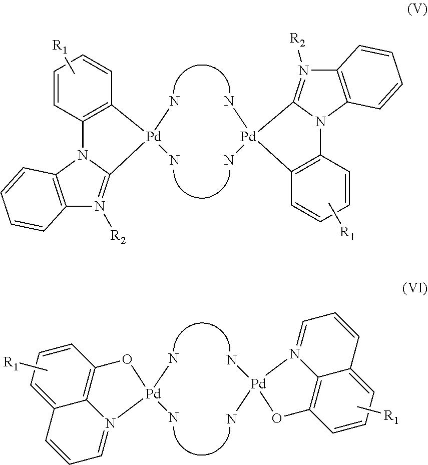

where the

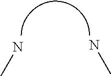

is selected from the group consisting of

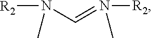

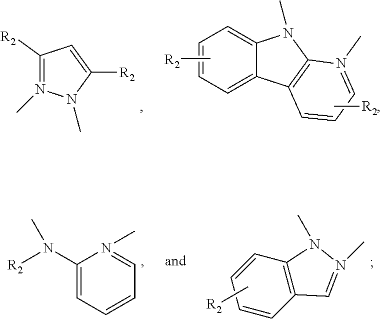

R₁ is selected from the group consisting of H, F, methyl, tert-butyl, and phenyl; and

R₂ is selected from the group consisting of H, alkyl, and phenyl.

Preferably, the cyclic metal palladium dimer has a structure shown in any one of (I-1), (I-2), (1-3), (II-1), (II-2), (II-3), (III-1), (III-2), and (III-3):

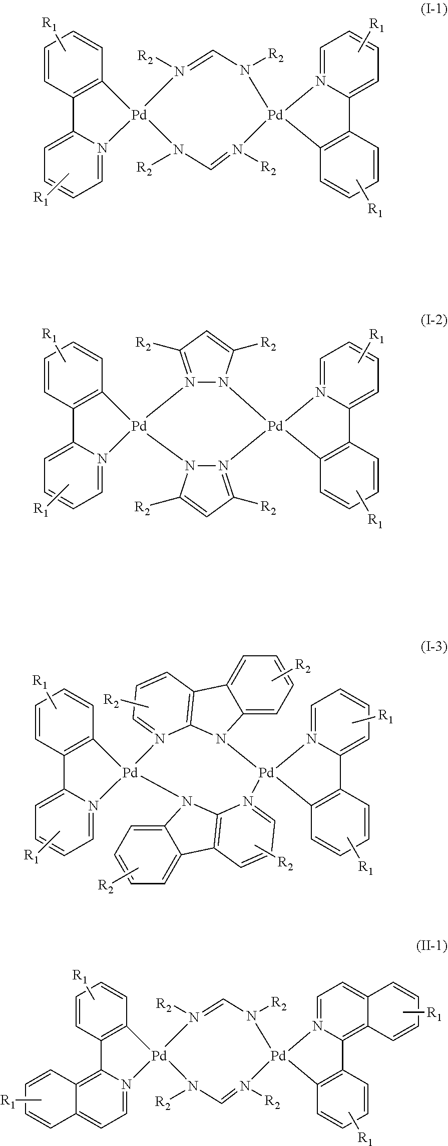

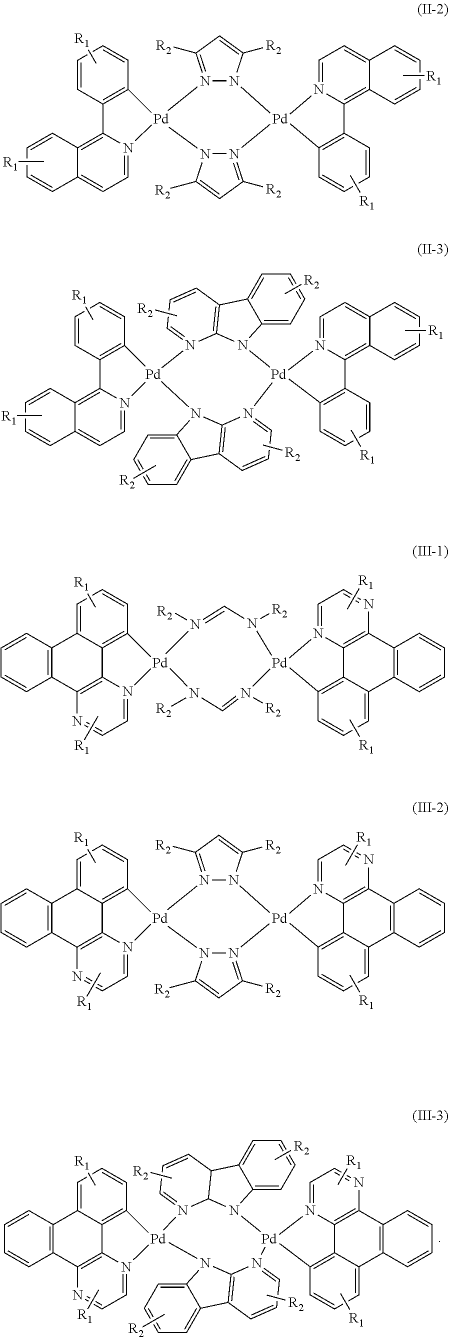

Preferably, the cyclic metal palladium dimer has a structure shown in any one of C₁ to C₁₃:

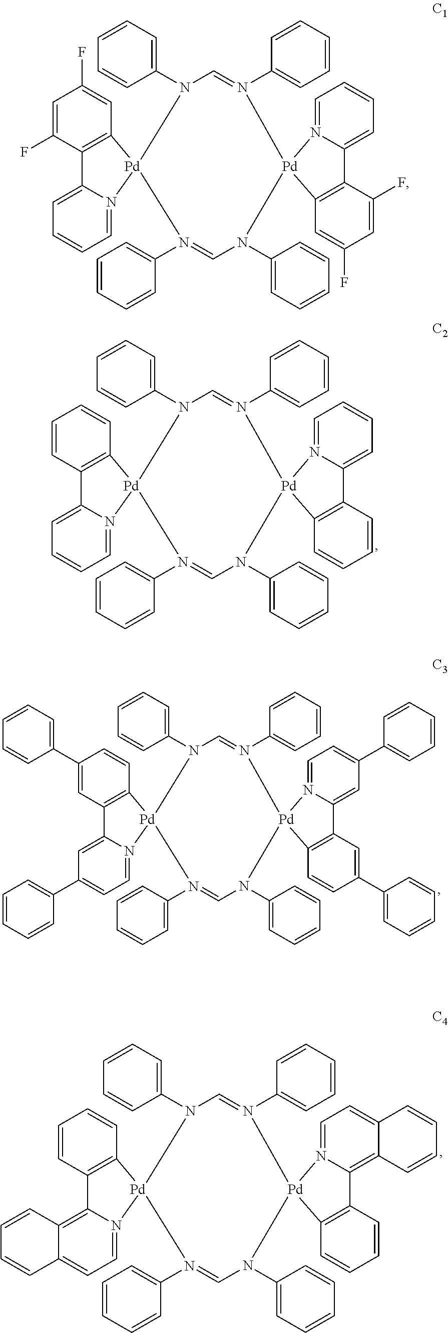

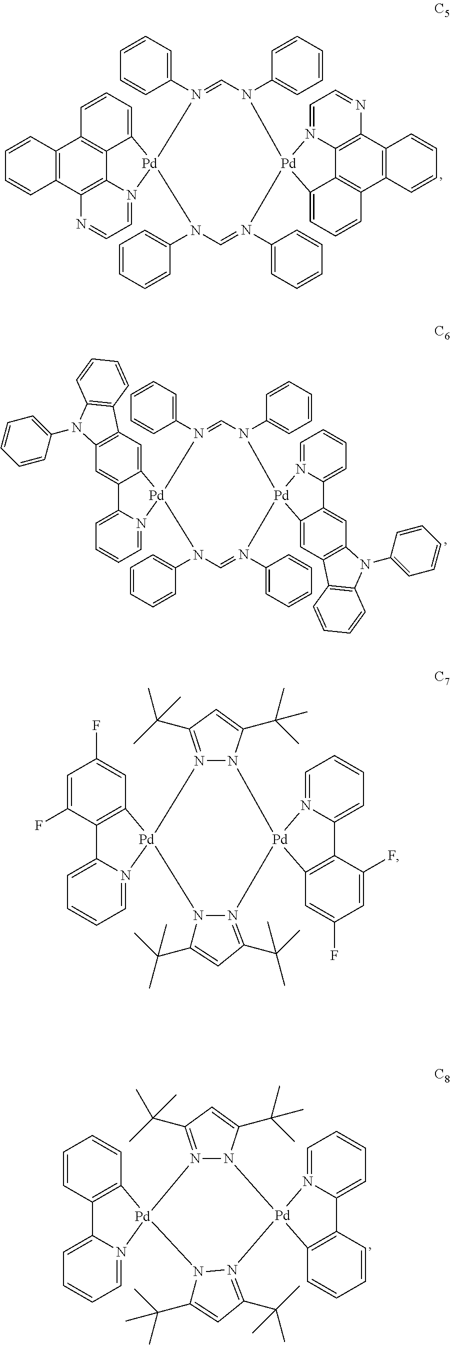

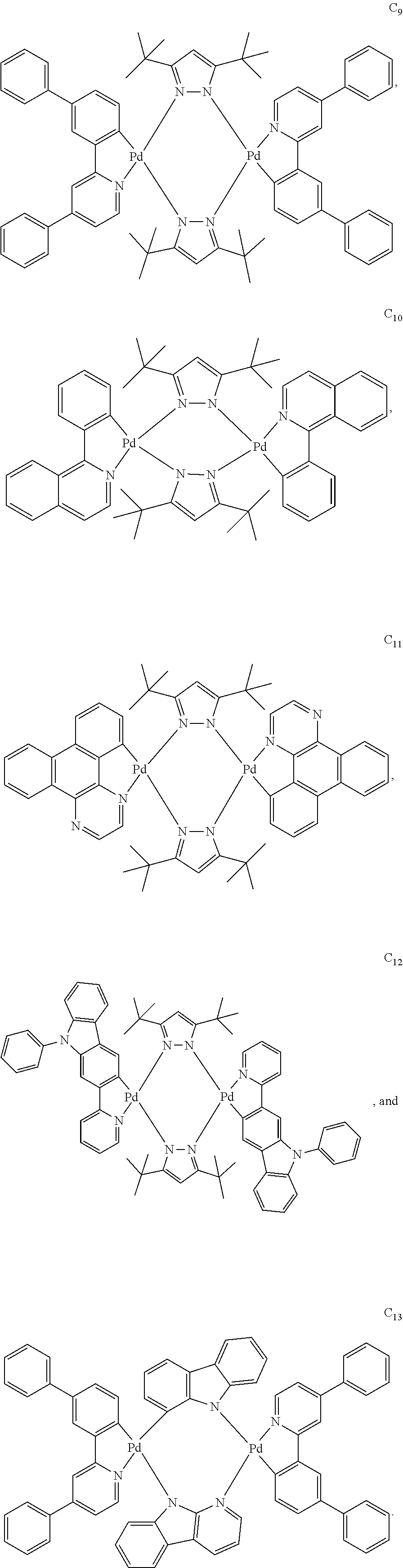

The present disclosure further provides a preparation method of the cyclic metal palladium dimer, including the following steps: mixing a cyclic metal palladium carboxylic acid dimer,

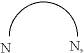

a first polar solvent, and an alkaline reagent to allow a displacement reaction to obtain the cyclic metal palladium dimer; where

the cyclic metal palladium carboxylic acid dimer has a structure shown in any one of (XIV) to (XIX):

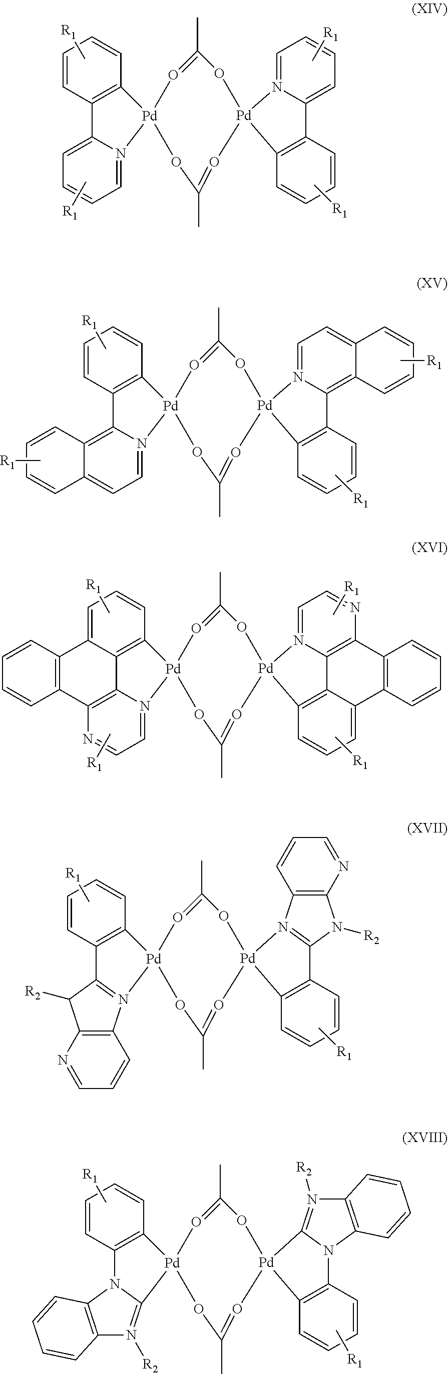

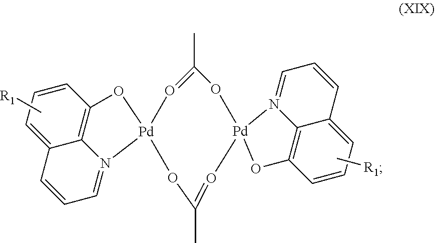

and

the

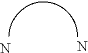

is selected from the group consisting of

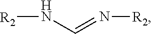

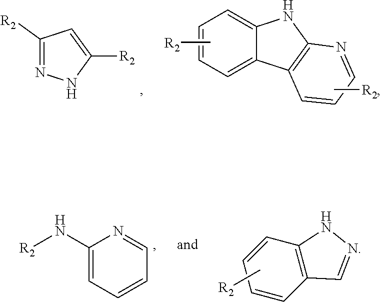

Preferably, the cyclic metal palladium carboxylic acid dimer and the

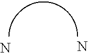

are at a molar ratio of 1:(2.1-5).

Preferably, the cyclic metal palladium carboxylic acid dimer and the alkaline reagent are at a molar ratio of 1:(2-4).

Preferably, the alkaline reagent is an alkali metal alkoxide.

Preferably, when the

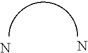

is the

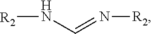

the first polar solvent is acetone;

when the

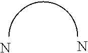

is the

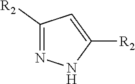

or the

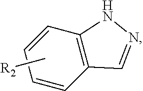

the first polar solvent is selected from the group consisting of acetone and methanol; and

when the

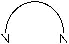

is the

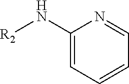

or the

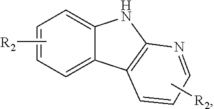

the first polar solvent is selected from the group consisting of acetone, methanol, and tetrahydrofuran.

Preferably, when the

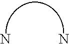

is the

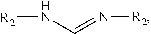

the displacement reaction is conducted in the dark for 5 h to 10 h; when the

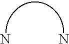

is the

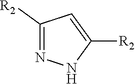

or the

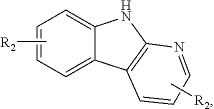

the displacement reaction is conducted at 45° C. to 70° C. for 3 h to 6 h;
and when the

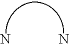

is the

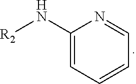

or the

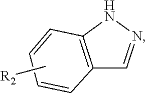

the displacement reaction is conducted at 45° C. to 80° C. for 5 h to 10 h.

The present disclosure further provides use of the cyclic metal palladium dimer or a cyclic metal palladium dimer prepared by the preparation method in an emission layer of an OLED.

The present disclosure provides a cyclic metal palladium dimer. The dimer has excellent luminous efficiency and long luminous lifetime, and can be used as a luminescent center for an emission layer of an OLED.

### BRIEF DESCRIPTION OF THE DRAWINGS

FIG. 1 to FIG. 10 show molecular structure diagrams of cyclic metal palladium dimers C₁, C₃, C₄, C₆, C₇, C₈, C₉, C₁₀, C₁₂, and C₁₃;

FIG. 11 shows an ultraviolet-visible absorption spectrum of the cyclic metal palladium dimers C₁ to C₆ in a solution state at 25° C.;

FIG. 12 shows an ultraviolet-visible absorption spectrum of the cyclic metal palladium dimers C₇ to C₁₁ in a solution state at 25° C.;

FIG. 13 shows a normalized emission spectrum at 25° C. of the cyclic metal palladium dimers C₁ to C₆ in a PMMA thin film of 2% by mass fraction on a quartz plate;

FIG. 14 shows a normalized emission spectrum at 25° C. of the cyclic metal palladium dimers C₇ to C₁₁ in a PMMA thin film of 2% by mass fraction on a quartz plate;

FIG. 15 shows a normalized emission spectrum of the cyclic metal palladium dimers C₁ to C₆ in a solid powder state at 25° C.; and

FIG. 16 shows a normalized emission spectrum of the cyclic metal palladium dimers C₇ to C₁₁ in a solid powder state at 25° C.

### DETAILED DESCRIPTION OF THE EMBODIMENTS

The present disclosure provides a cyclic metal palladium dimer, having a structure shown in any one of (I) to (VI):

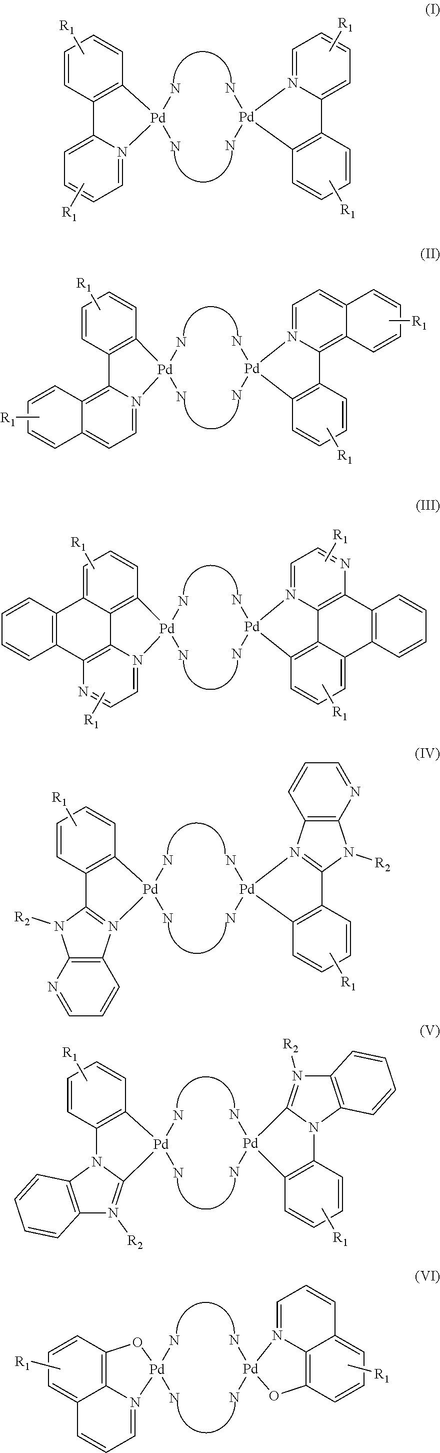

the

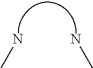

is selected from the group consisting of

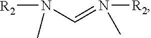

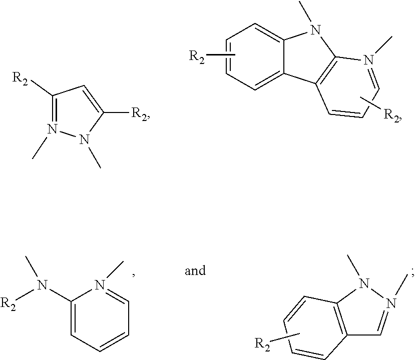

R₁ is selected from the group consisting of H, F, methyl, tert-butyl, and phenyl; and

R₂ is selected from the group consisting of H, alkyl, and phenyl.

In the present disclosure, the alkyl is preferably selected from the group consisting of tert-butyl, methyl, ethyl, and isopropyl.

In the present disclosure, the cyclic metal palladium dimer belongs to a complex of palladium, where N and Pd are connected through coordination bonds.

In the present disclosure, the cyclic metal palladium dimer has a structure preferably shown in any one of (I-1), (I-2), (I-3), (II-1), (II-2), (II-3), (III-1), (III-2), and (III-3), more preferably shown in any one of C₁ to C₁₃ (listed above, not repeated here).

The present disclosure further provides a preparation method of the cyclic metal palladium dimer, including the following steps: mixing a cyclic metal palladium carboxylic acid dimer,

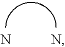

a first polar solvent, and an alkaline reagent to allow a displacement reaction to obtain the cyclic metal palladium dimer; where

the cyclic metal palladium carboxylic acid dimer has a structure shown in any one of formulas (XIV) to (XIX):

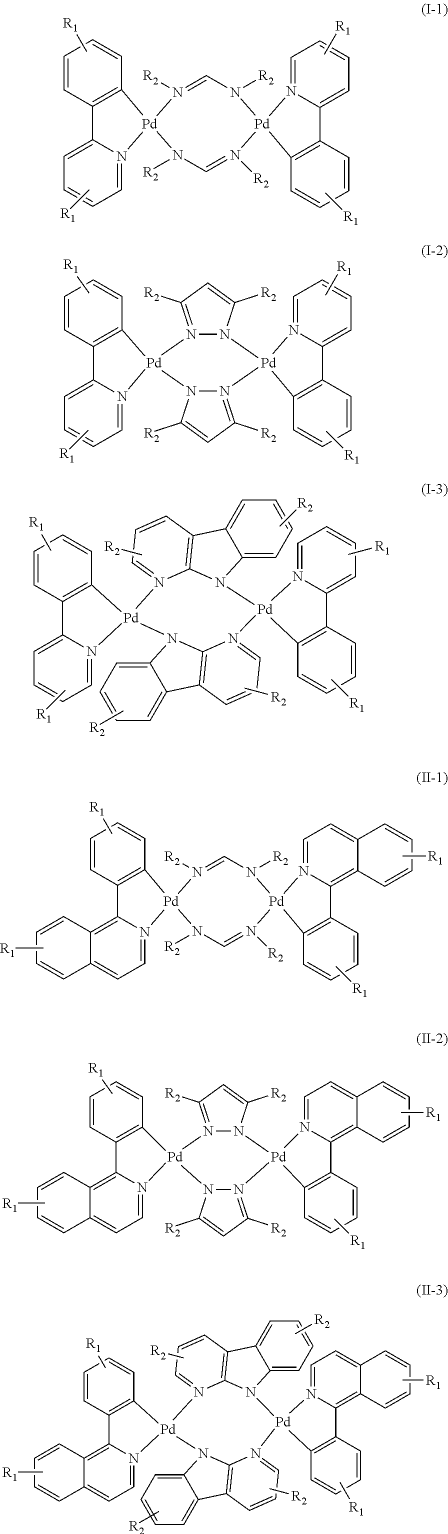

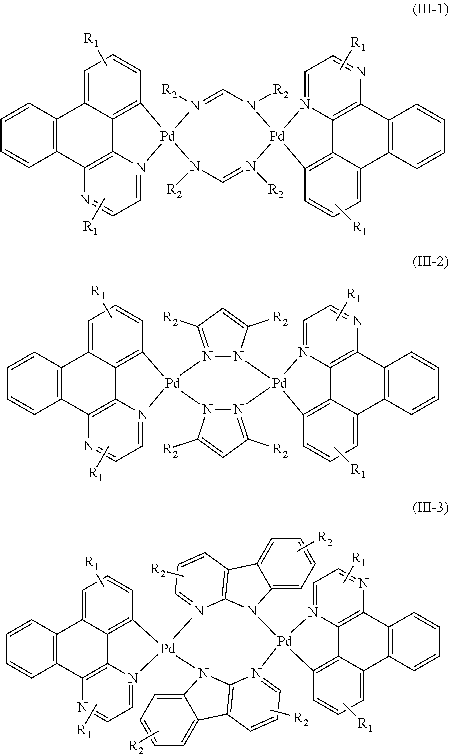

In the present disclosure, unless otherwise specified, the raw materials used are commercially available products or prepared by methods well known in the art.

In the present disclosure, the cyclic metal palladium carboxylic acid dimer is preferably self-prepared. A preparation method of the cyclic metal palladium carboxylic acid dimer includes preferably the following steps:

dissolving a ligand in a second polar solvent, adding palladium acetate into a resulting solution to allow an addition reaction to obtain the cyclic metal palladium carboxylic acid dimer; where the ligand has a structure shown in any one of (VIII) to (XIII):

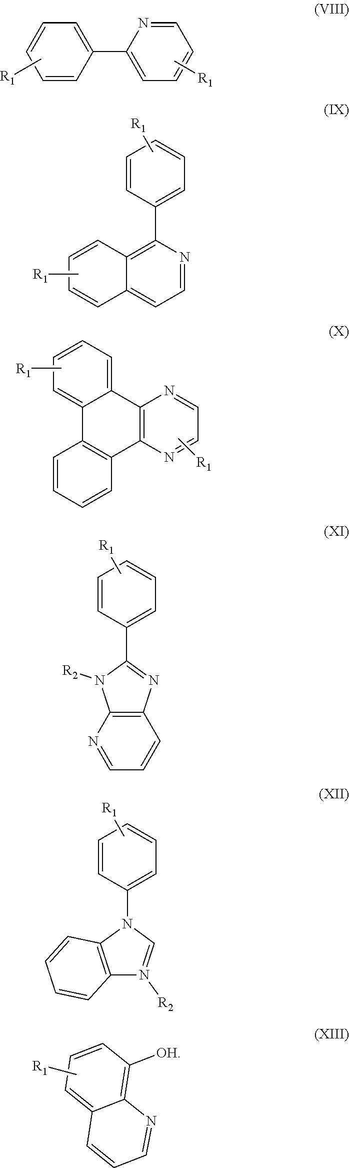

In the present disclosure, the ligand and the palladium acetate are at a molar ratio of preferably 1:(1-1.1).

In the present disclosure, the second polar solvent is preferably selected from the group consisting of dichloromethane and glacial acetic acid. There is no special requirement on a dosage of the second polar solvent, as long as the ligand can be completely dissolved.

In the present disclosure, the addition reaction is preferably conducted under stirring for preferably 8 h to 12 h, more preferably 9 h to 11 h. When the second polar solvent is the dichloromethane, the addition reaction is conducted at preferably a room temperature; and when the second polar solvent is the glacial acetic acid, the addition reaction is conducted at preferably 80° C. to 100° C. under reflux conditions.

In the present disclosure, an equation of the addition reaction is as follows:

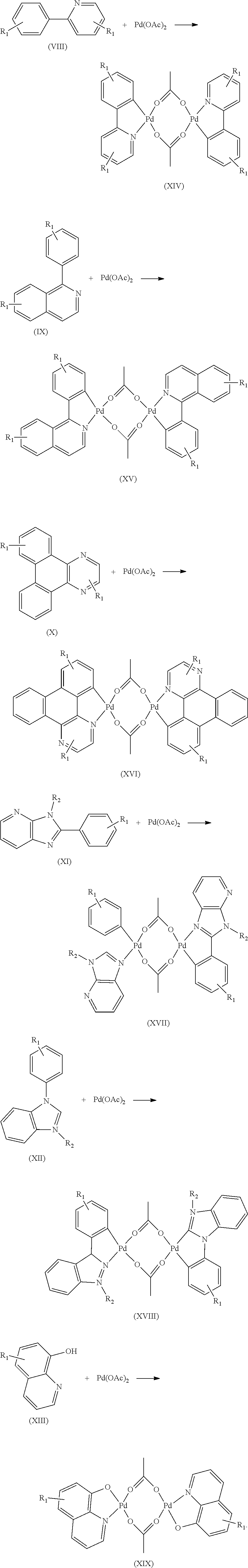

In the present disclosure, after the addition reaction is completed, an obtained reaction mixture is preferably spin-dried, washed with ether, and then purified by recrystallization to obtain the cyclic metal palladium carboxylic acid dimer.

In the present disclosure, the cyclic metal palladium carboxylic acid dimer, the

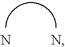

the first polar solvent, and the alkaline reagent are mixed to allow a displacement reaction to obtain the cyclic metal palladium dimer.

In the present disclosure, the cyclic metal palladium carboxylic acid dimer and the

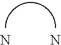

are at a molar ratio of preferably 1:(2.1-5), more preferably 1:(2.5-4.5), and even more preferably 1:(3-4).

In the present disclosure, the alkaline reagent is preferably an alkali metal alkoxide; and the alkali metal alkoxide is preferably selected from the group consisting of sodium methoxide and potassium tert-butoxide. The cyclic metal palladium carboxylic acid dimer and the alkaline reagent are at a molar ratio of preferably 1:(2-4), more preferably 1:3.

In the present disclosure, a type of the first polar solvent and conditions of the displacement reaction are preferably determined according to a type of the

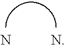

### When the

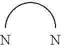

is the

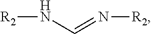

the first polar solvent is preferably acetone; and the displacement reaction is preferably conducted in the dark for preferably 5 h to 10 h, more preferably 6 h to 9 h, and even more preferably 7 h to 8 h.

When the

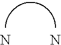

is the

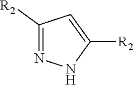

or the

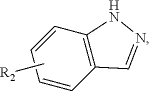

the first polar solvent is preferably selected from the group consisting of acetone and methanol; and the displacement reaction is conducted at preferably 45° C. to 70° C., more preferably 50° C. to 65° C. for preferably 3 h to 6 h, more preferably 4 h to 5 h.

When the

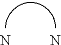

is the

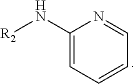

or the

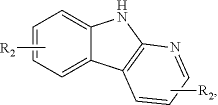

the first polar solvent is preferably selected from the group consisting of acetone, methanol, or tetrahydrofuran; and the displacement reaction is conducted at preferably 45° C. to 80° C., more preferably 50° C. to 75° C. for preferably 5 h to 10 h, more preferably 6 h to 8 h.

In the present disclosure, after the displacement reaction is completed, an obtained displacement reaction mixture is preferably subjected to rotary evaporation to remove the solvent, washed with methanol until an obtained washing solution is clear, and purified to obtain the cyclic metal palladium dimer.

In the present disclosure, a purification method is preferably determined according to a type of the

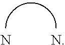

### When the

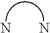

is the

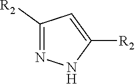

or the

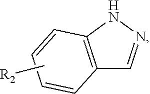

the purification is preferably conducted by recrystallization; and when the

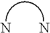

is other substances, the purification is preferably conducted by column chromatography isolation. There is no special requirement for a process of the recrystallization and the column chromatography isolation, as long as a target product can be purified.

The present disclosure further provides use of the cyclic metal palladium dimer or a cyclic metal palladium dimer prepared by the preparation method in an emission layer of an OLED.

The cyclic metal palladium dimer, and the preparation method and the use thereof. provided by the present disclosure are described in detail below in conjunction with the examples, but these examples should not be construed as limiting the protection scope of the present disclosure.

### EXAMPLE 1

A synthetic route of a cyclic metal palladium dimer C₁ included the following steps:

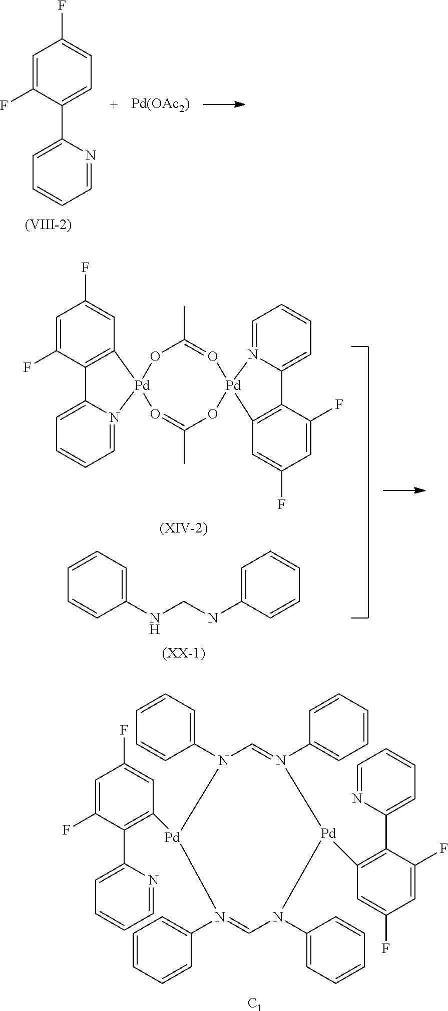

Specific preparation steps were as follows:
(i) A ligand VIII-2 (426 mg, 2.23 mmol) was dissolved in 40 mL of dichloromethane in a round bottom flask, and palladium acetate (500 mg, 2.23 mmol) was added into the round bottom flask and stirred to allow a reaction for 10 h. After the reaction was completed, an obtained mixture was spin-dried, washed three times with diethyl ether, and purified by recrystallization to obtain a cyclic metal palladium carboxylic acid dimer XIV-2.
(ii) The cyclic metal palladium carboxylic acid dimer XIV-2 (200 mg, 0.28 mmol), XX-1 (138 mg, 0.70 mmol), and sodium methoxide (46 mg, 0.84 mmol) were added into the round bottom flask, and 20 mL of acetone was added to allow a reaction at a room temperature in the dark for 8 h. After the reaction was completed, an obtained reaction mixture was subjected to rotary evaporation to remove the solvent, washed three times with methanol until an obtained washing solution was clear, and purified by column chromatography isolation to obtain the cyclic metal palladium dimer C₁.

### EXAMPLE 2

A synthetic route of a cyclic metal palladium dimer C₂ included the following steps:

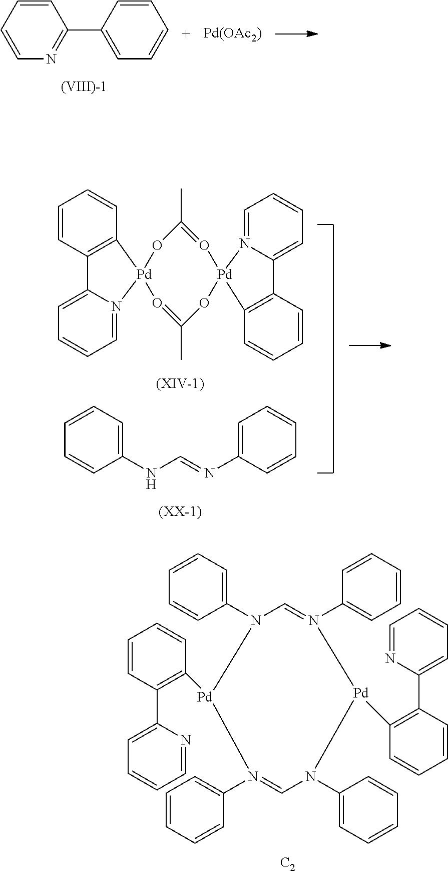

The specific preparation steps referred to Example 1, the only difference was that the compound VIII-2 was replaced by a compound VIII-1.

### EXAMPLE 3

A synthetic route of a cyclic metal palladium dimer C₃ included the following steps:

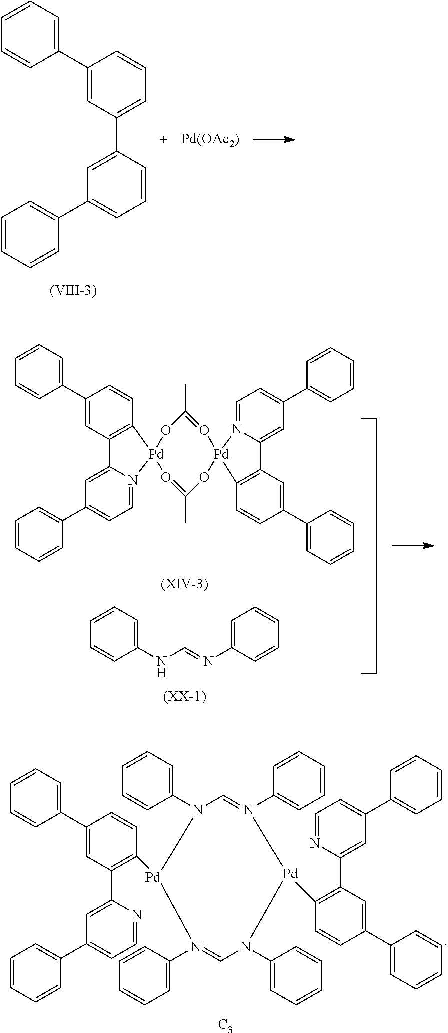

The specific preparation steps referred to Example 1, the only difference was that the compound VIII-2 was replaced by a compound VIII-1.

### EXAMPLE 4

A synthetic route of a cyclic metal palladium dimer C₄ included the following steps:

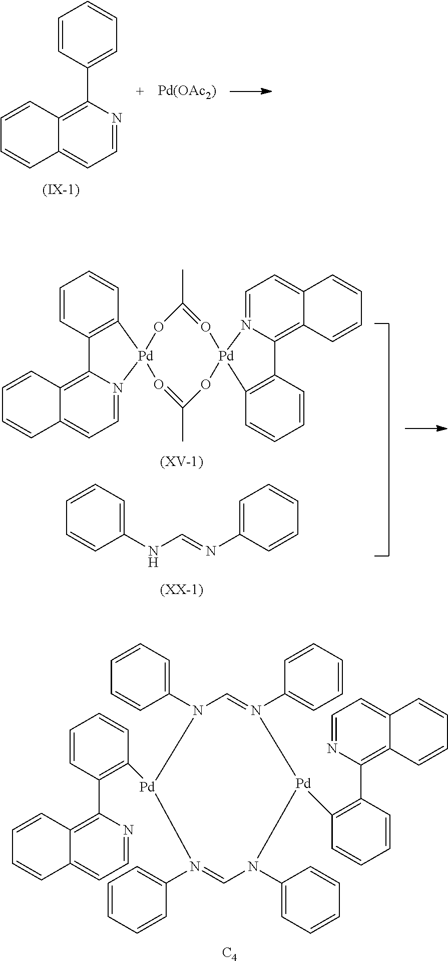

The specific preparation steps referred to Example 1, the only difference was that the compound VIII-2 was replaced by a compound IX-1.

### EXAMPLE 5

A synthetic route of a cyclic metal palladium dimer C₅ included the following steps:

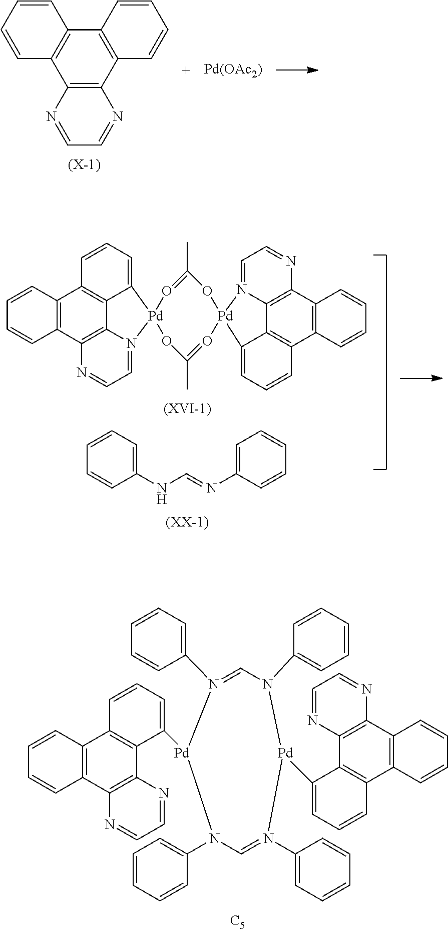

The specific preparation steps referred to Example 1, the only difference was that the compound VIII-2 was replaced by a compound X-1.

### EXAMPLE 6

A synthetic route of a cyclic metal palladium dimer C₆ included the following steps:

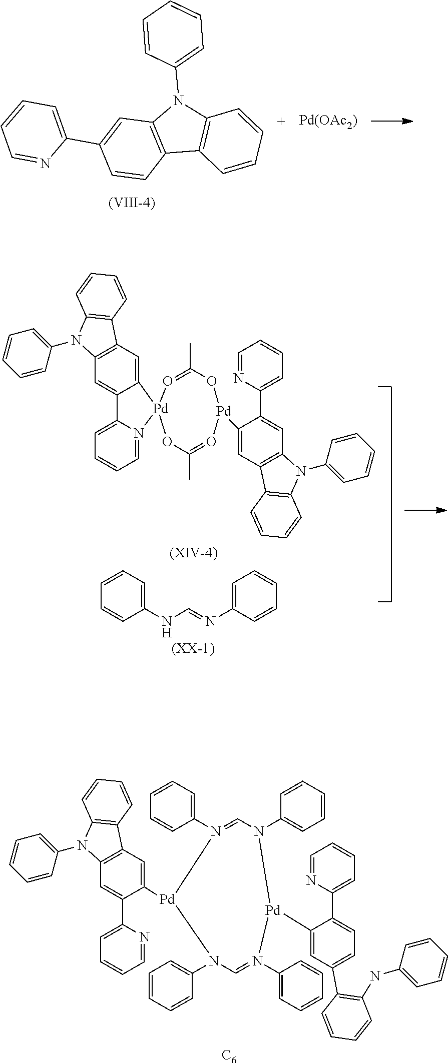

The specific preparation steps referred to Example 1, the only difference was that the compound VIII-2 was replaced by a compound VIII-4.

### EXAMPLE 7

A synthetic route of a cyclic metal palladium dimer C₇ included the following steps:

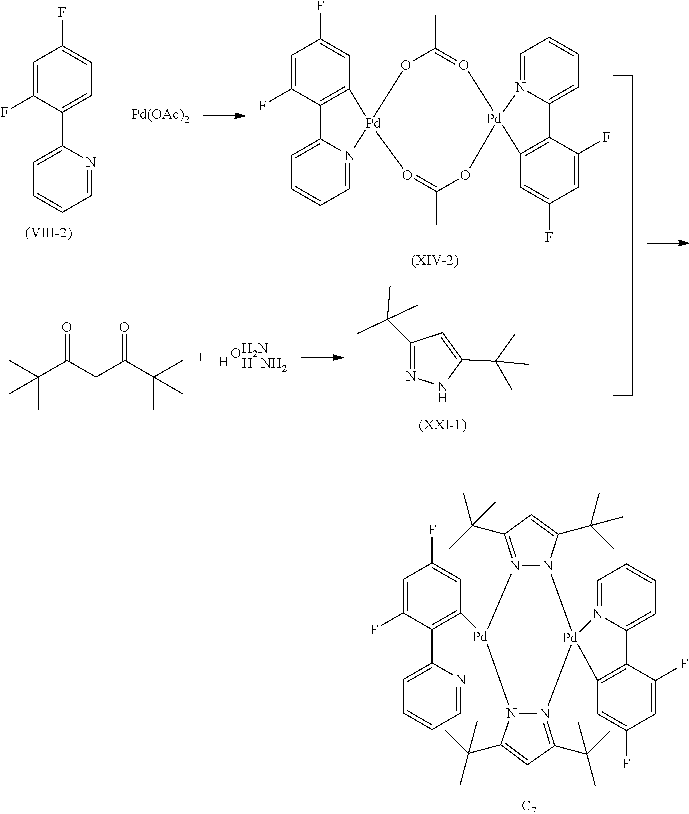

Specific preparation steps were as follows:
(i) The specific preparation steps were conducted with reference to (i) of Example 1.
(ii) A mixture of 2,2,6,6-tetramethyl-3,5-heptanedione (220 mg, 1.00 mmol) and hydrazine hydrate (50 mg, 1.00 mmol) were placed in a round bottom flask and heated at 70° C. for 2 h to obtain a compound XXI-1. After the reaction was completed, a product was obtained as a white solid which required no further purification.
(iii) A cyclic metal palladium carboxylic acid dimer XIV-2 (200 mg, 0.28 mmol), the XXI-1 (127 mg, 0.70 mmol), and sodium methoxide (46 mg, 0.84 mmol) were added into a pressure flask, and 6 mL of acetone was added into the pressure flask to allow a reaction by heating at 65° C. for 5 h. After the reaction was completed, an obtained reaction mixture was cooled to a room temperature, subjected to rotary evaporation to remove the solvent, washed three times with methanol until an obtained washing solution was clear, and purified by column chromatography isolation to obtain the cyclic metal palladium dimer C₇.

### EXAMPLE 8

A synthetic route of a cyclic metal palladium dimer C₈ included the following steps:

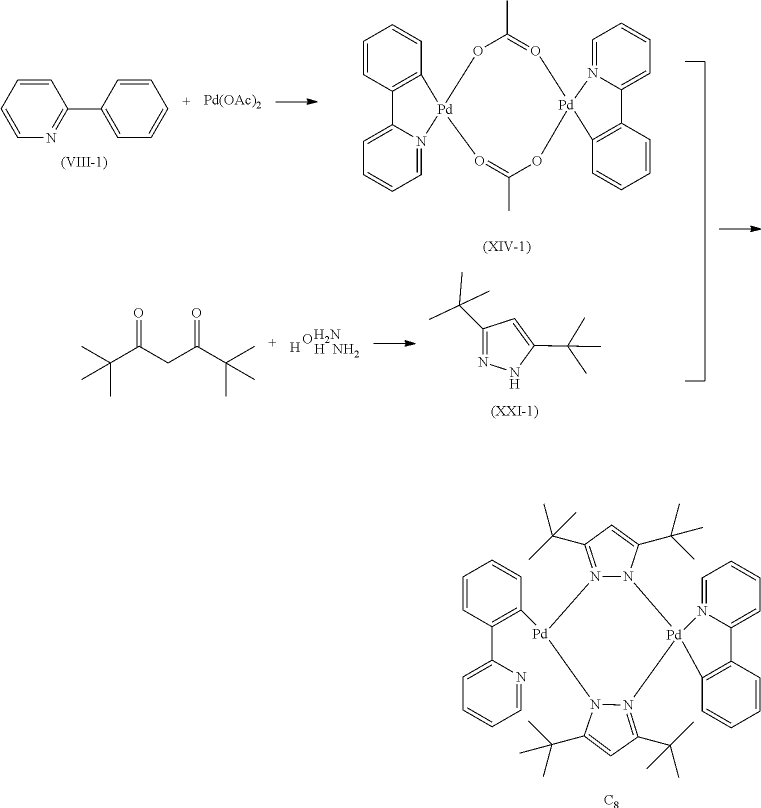

The specific preparation steps referred to Example 7, the only difference was that the compound VIII-2 was replaced by a compound VIII-1.

### EXAMPLE 9

A synthetic route of a cyclic metal palladium dimer C₉ included the following steps:

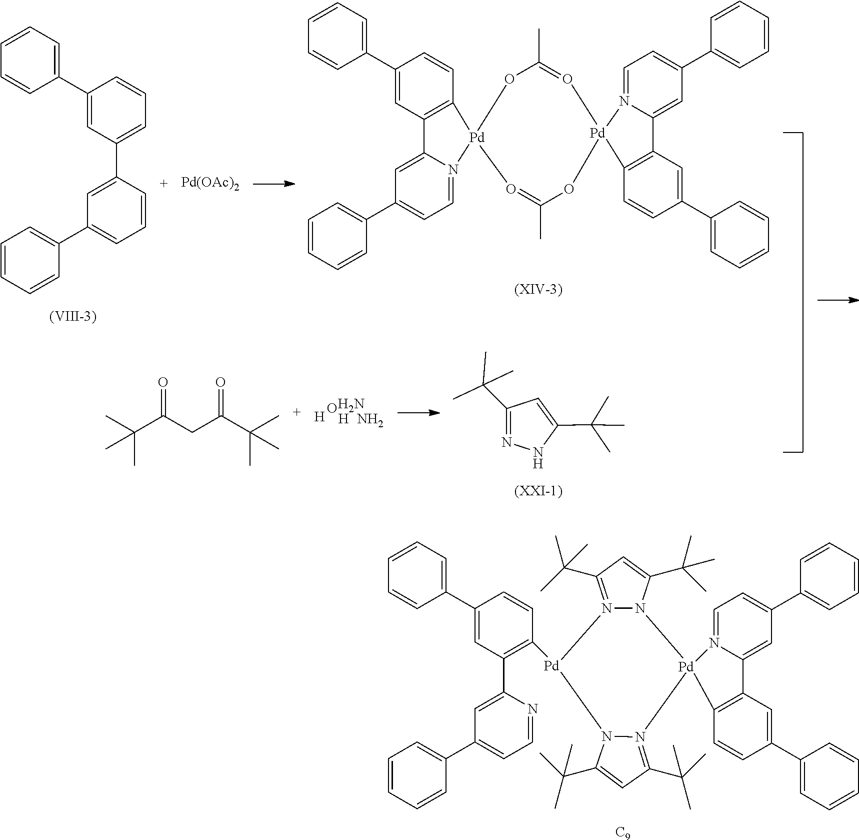

The specific preparation steps referred to Example 7, the only difference was that the compound VII-1 was replaced by a compound VII-3.

### EXAMPLE 10

A synthetic route of a cyclic metal palladium dimer C₁₀ included the following steps:

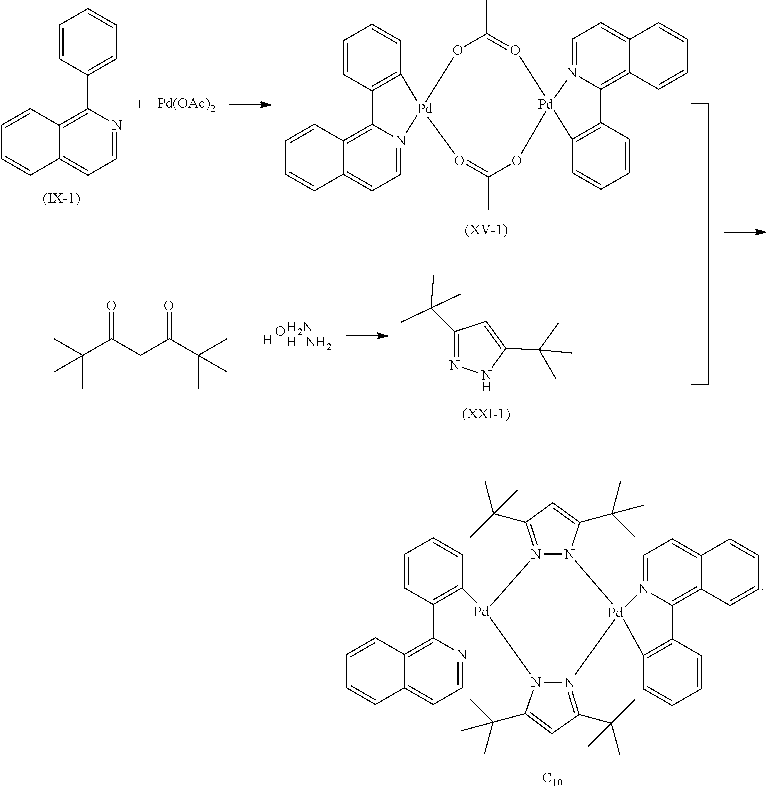

The specific preparation steps referred to Example 7, the only difference was that the compound VIII-2 was replaced by a compound IX-1.

### EXAMPLE 11

A synthetic route of a cyclic metal palladium dimer C₁₁ included the following steps:

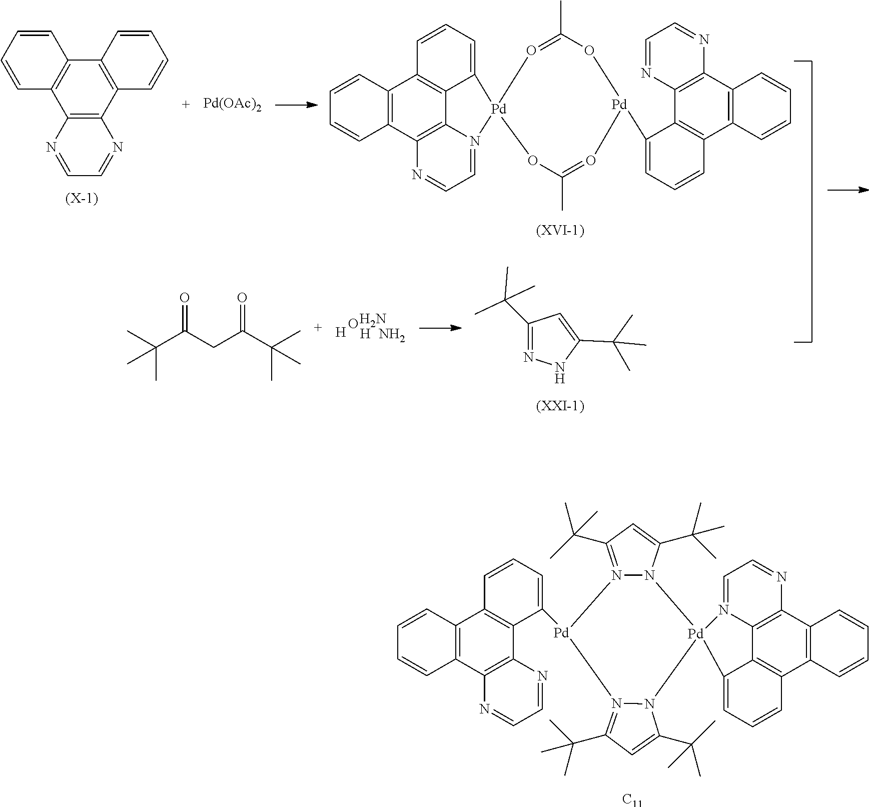

The specific preparation steps referred to Example 7, the only difference was that the compound VIII-2 was replaced by a compound X-1.

### EXAMPLE 12

A synthetic route of a cyclic metal palladium dimer C₁₂ included the following steps:

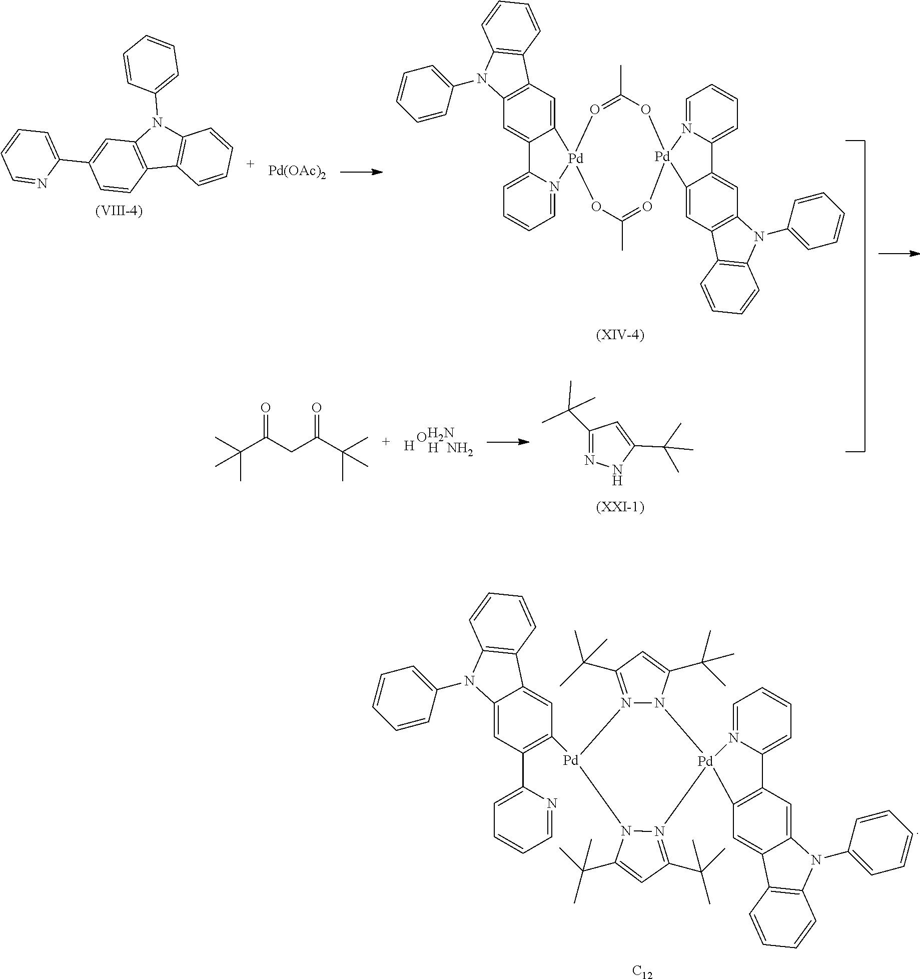

The specific preparation steps referred to Example 7, the only difference was that the compound VIII-2 was replaced by a compound VIII-4.

### EXAMPLE 13

A synthetic route of a cyclic metal palladium dimer C₁₃ included the following steps:

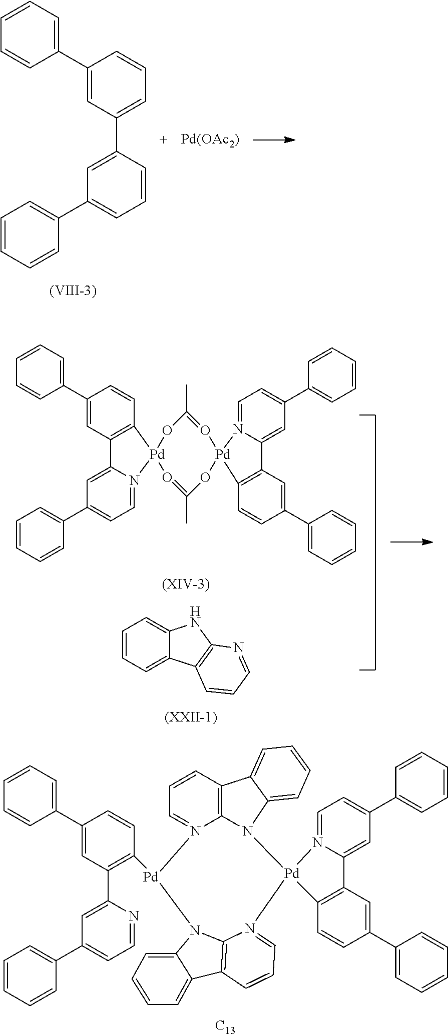

The specific preparation steps referred to Example 7, the only difference was that the compound VIII-2 was replaced by a compound VIII-3, and the compound XXI-1 was replaced by a compound XXII-1.

### Structure and Performance Characterization

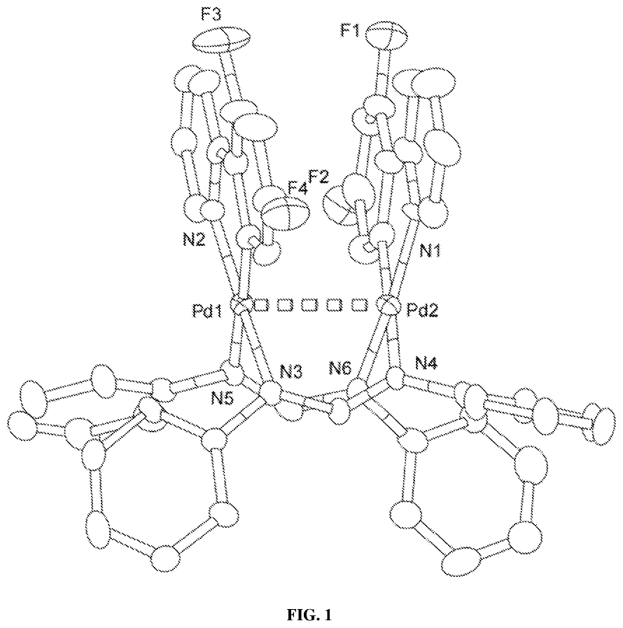

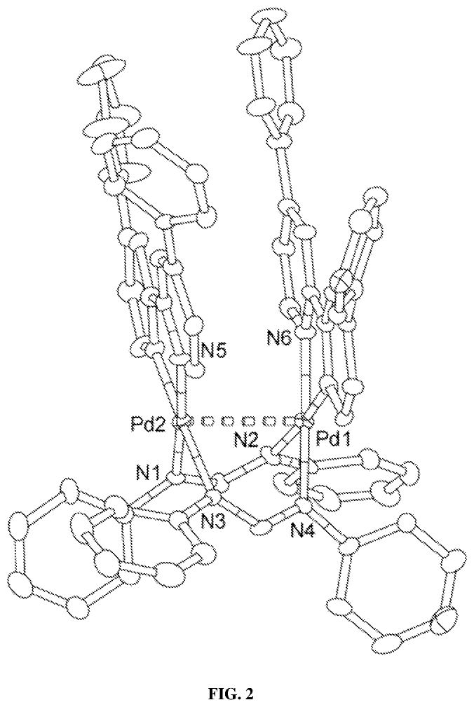

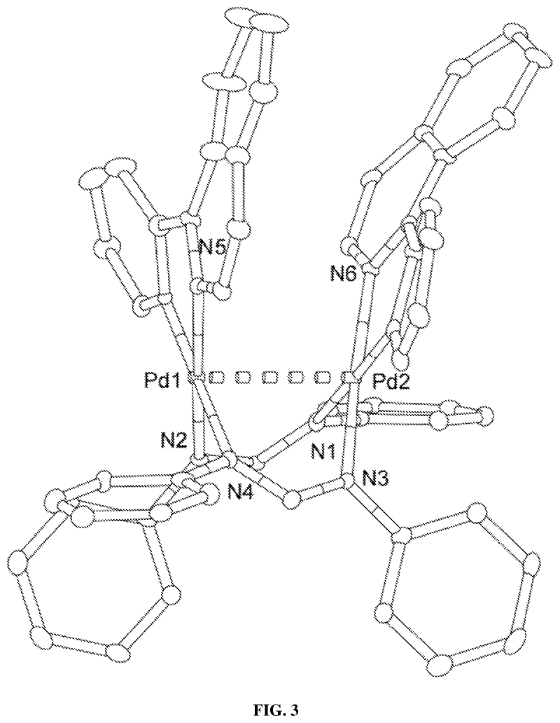

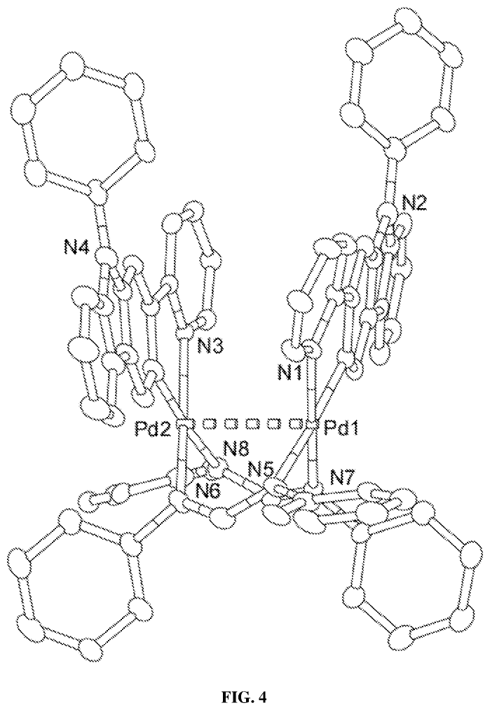

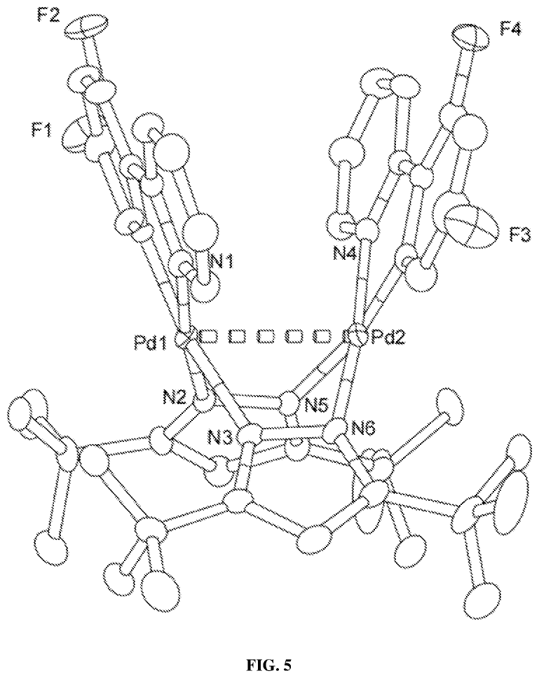

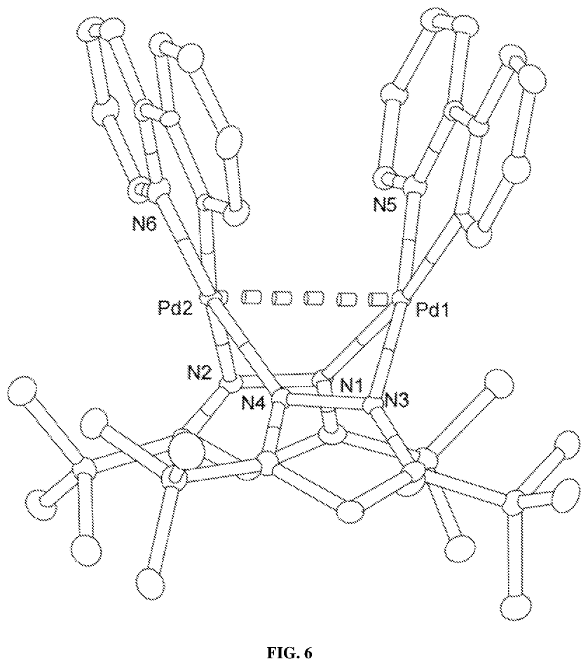

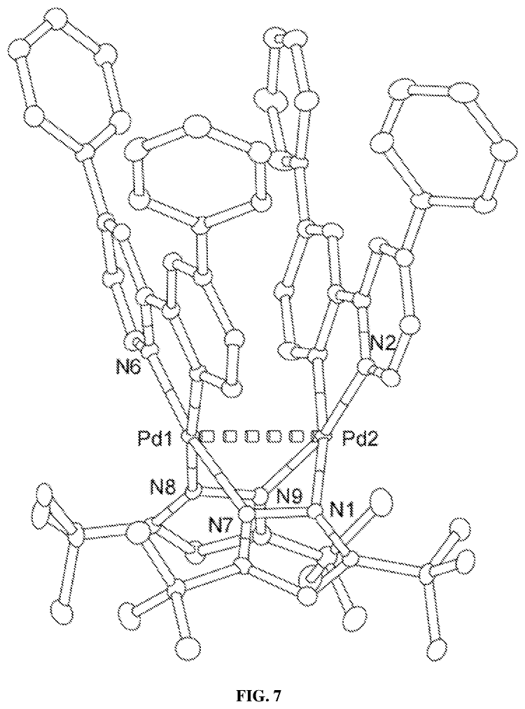

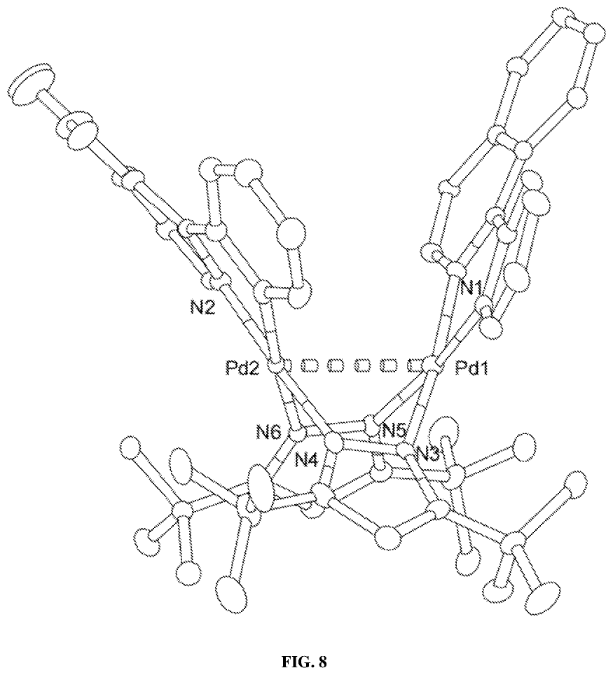

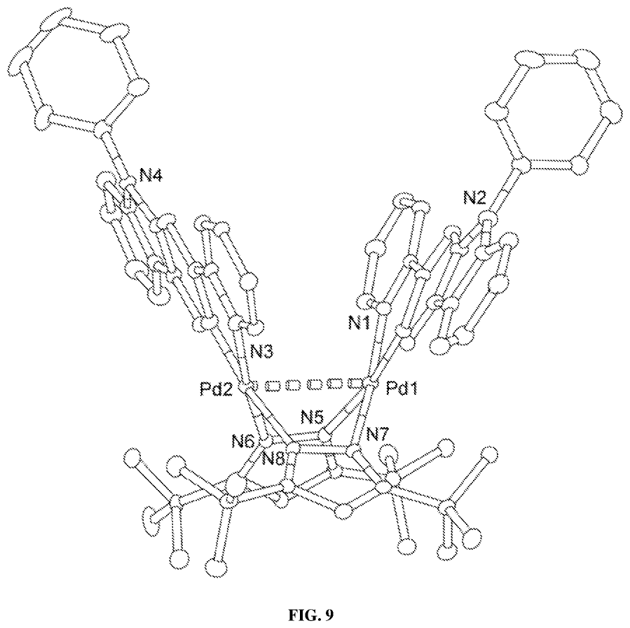

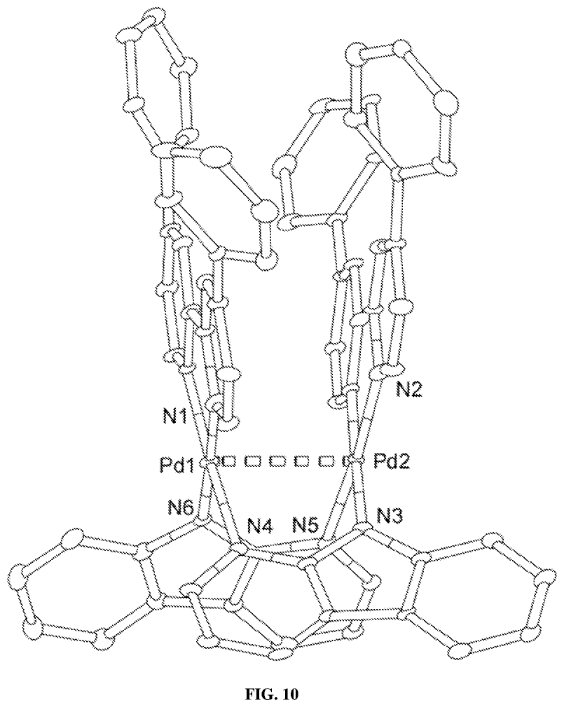

The molecular structures of C₁, C₃, C₄, C₆, C₇, C₈, C₉, C₁₀, C₁₂, and C₁₃ were analyzed by single crystal X-ray diffraction (SC-XRD), and the results were shown in FIG. 1 to FIG. 10 in sequence. In FIG. 1 to FIG. 10, thermal ellipsoids were plotted at a probability level of 30%. Hydrogen atoms were omitted for clarity. As shown in FIG. 1 to FIG. 10, cyclic metal palladium dimers with target structures were obtained.

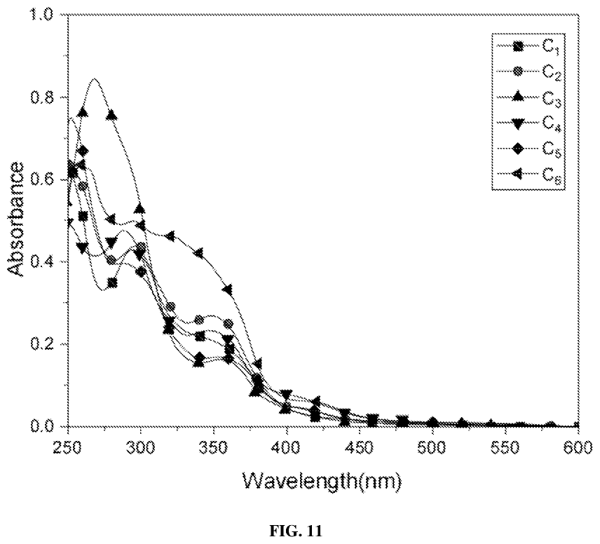

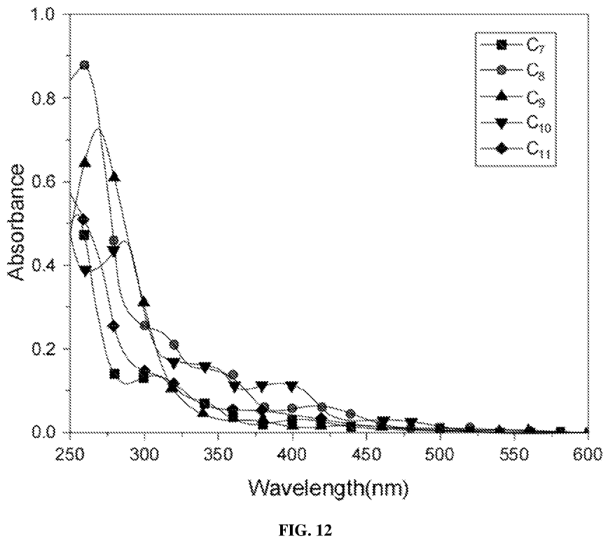

The cyclic metal palladium dimers C₁ to C₁₁ were separately dissolved in dichloromethane, and their ultraviolet-visible absorption spectra were measured at 25° C. The results were shown in FIG. 11 and FIG. 12.

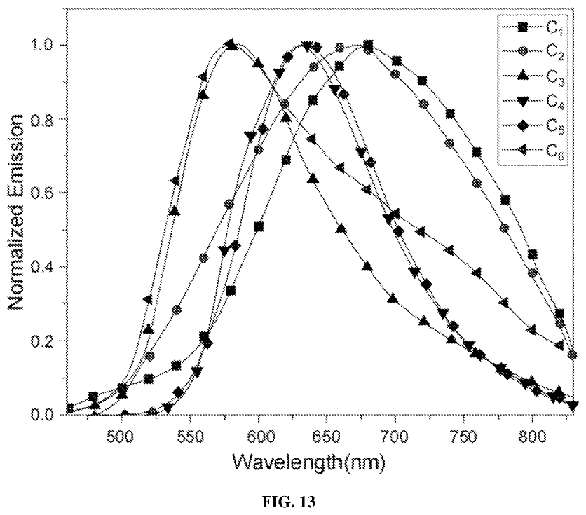

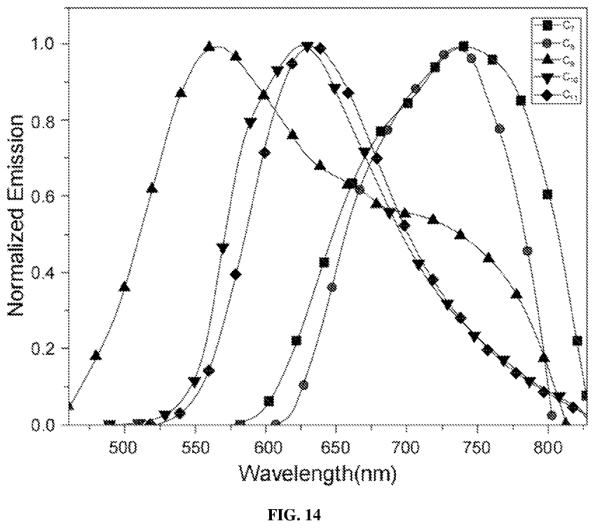

The cyclic metal palladium dimers C₁ to C₁₁ were placed on a quartz plate, and their normalized emission spectra were measured at 25° C. with a PMMA thin film of 2% by mass fraction (the 2% referred to a ratio of the cyclic metal palladium dimer to a total mass of the cyclic metal palladium dimer and the PMMA). The results were shown in FIG. 13 and FIG. 14.

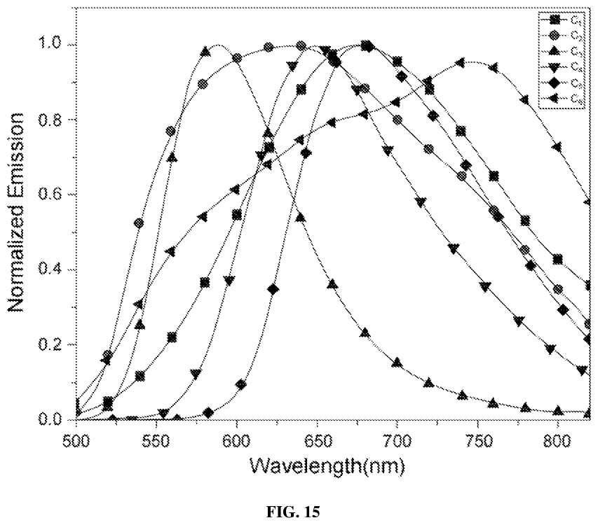

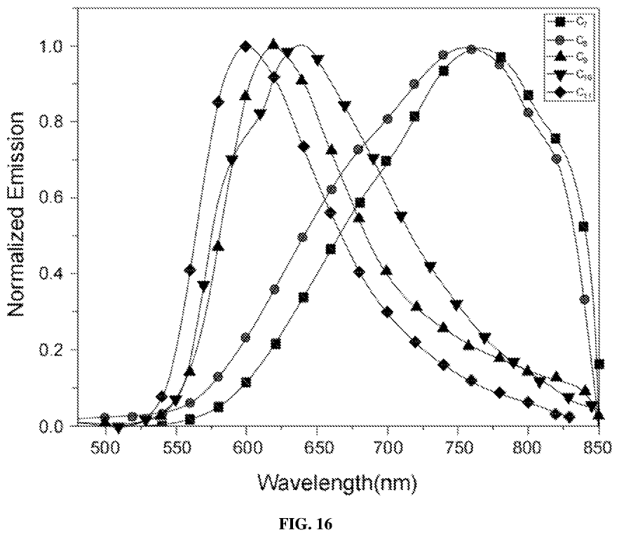

The normalized emission spectra at 25° C. of the cyclic metal palladium dimers C₁ to C₁₁ were measured in a solid powder state. The results were shown in FIG. 15 and FIG. 16.

The luminescent properties of the cyclic metal palladium dimer prepared in the present disclosure in the above different states were summarized below, as shown in Table 1 for details.

TABLE 1
Photophysical properties of cyclic metal palladium dimers C1 to C11

| | | | Em | | | | |
|---|---|---|---|---|---|---|---|
| | Absorption | Medium | wavelength/ | Φ | τ | Kᵣ | Kₙᵣ |
| | (CH₂Cl₂)^{a}/nm | (T/K) | nm | (%) | (μs) | [10⁴s⁻¹] | [10⁵s⁻¹] |
| C₁ | 297, 353, 433 | Solid (298) | 673 | 22.49 | 12 | 1.9 | 0.65 |
| | | PMMA (298) | 675 | 5.97 | 20.33 | 0.3 | 0.46 |
| C₂ | 297, 351, 432 | Solid (298) | 635 | 35.55 | 13.38 | 2.7 | 0.48 |
| | | PMMA (298) | 670 | 2.38 | 23.09 | 0.1 | 0.42 |
| C₃ | 268, 362, 460 | Solid (298) | 587 | 58.5 | 8.07 | 7.3 | 0.51 |
| | | PMMA (298) | 587 | 16.31 | 8.8 | 1.9 | 0.95 |
| C₄ | 290, 354, 495 | Solid (298) | 648 | 7.78 | 3.98 | 2 | 2.32 |
| | | PMMA (298) | 634 | 18.73 | 7.55 | 2.5 | 1.08 |
| C₅ | 413, 483 | Solid (298) | 678 | 24.32 | 2.05 | 11.9 | 3.70 |
| | | PMMA (298) | 634 | 43.01 | 4.68 | 9.2 | 1.20 |
| C₆ | 420 | Solid (298) | 740 | 3.97 | 5.28 | 0.8 | 1.82 |
| | | PMMA (298) | 582 | 1.3 | 14.86 | 0.1 | 0.66 |
| C₇ | 254, 311, 353, 415 | Solid (298) | 764 | 5.51 | 3.66 | 1.5 | 2.58 |
| | | PMMA (298) | 745 | 5.75 | 5.78 | 1 | 1.63 |
| C₈ | 262, 314, 357, 420 | Solid (298) | 757 | 1.74 | 12 | 0.2 | 0.82 |
| | | PMMA (298) | 738 | 0.34 | 4.81 | 0.1 | 2.07 |
| C₉ | 268, 370, 441 | Solid (298) | 622 | 7.17 | 10.5 | 0.7 | 0.88 |
| | | PMMA (298) | 580 | 1.89 | 5.88 | 0.3 | 1.67 |
| C₁₀ | 288, 350, 395, 470 | Solid (298) | 635 | 7.78 | 8 | 1 | 1.15 |
| | | PMMA (298) | 630 | 12.05 | 11.47 | 1 | 0.77 |
| C₁₁ | 420, 500 | Solid (298) | 601 | 14.58 | 15.11 | 1 | 0.57 |
| | | PMMA (298) | 635 | 20.3 | 4.47 | 4.5 | 1.78 |

Notes: In Table 1, “a” represented the compound measured in dichloromethane at room temperature, “Em” represented “emission wavelength”, “Φ” represented “phosphorescence quantum yield”, “τ” represented “phosphorescence lifetime”, “Solid” represented “solid state”, and “PMMA” represented “PMMA film state”. The phosphorescent quantum yield was measured using an integrating sphere. The radiative rate constant (Kᵣ) and the non-radiative rate constant (Kₙᵣ) were estimated by using the following equations: Kᵣ=Φ/τ, Kₙᵣ=(1−Φ)/τ.

As shown in Table 1, the cyclic metal palladium dimer provided by the present disclosure had excellent quantum yield and phosphorescence lifetime at the micron level. This indicated that the dimer showed a long luminous lifetime, meeting the preparation requirements of OLEDs devices.

What is claimed is:

1. A cyclic metal palladium dimer, having a structure shown in any one of (I) to (VI): 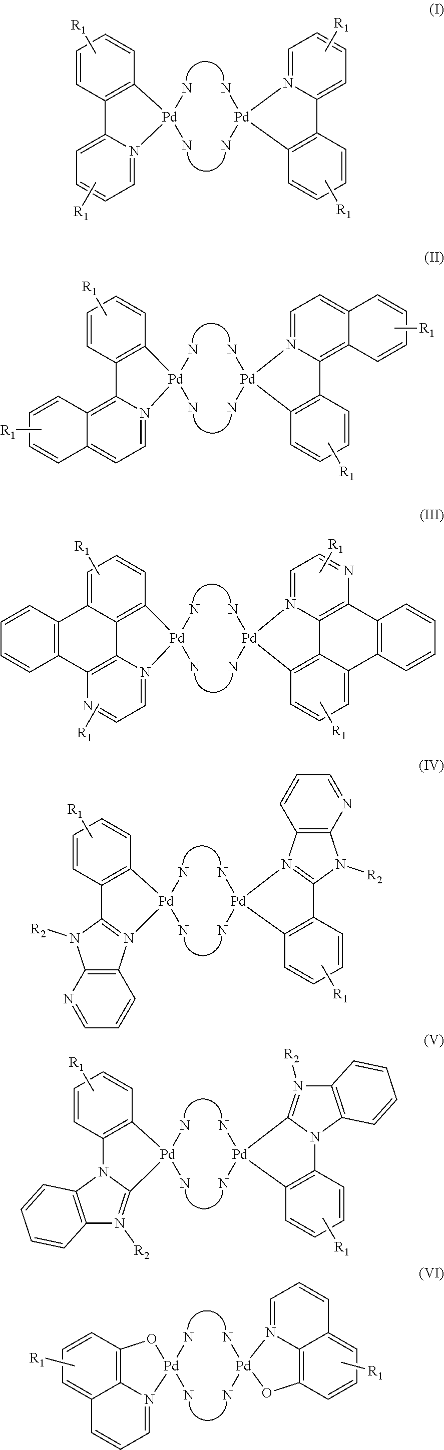
wherein the 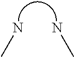
is selected from the group consisting of 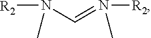 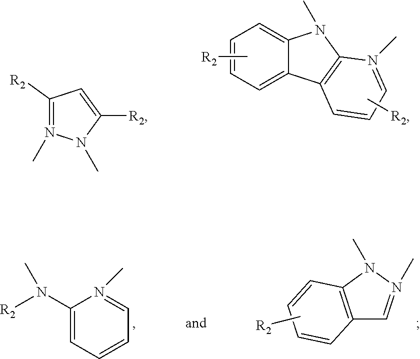
R₁ is selected from the group consisting of H, F, methyl, tert-butyl, and phenyl; and
R₂ is selected from the group consisting of H, alkyl, and phenyl.

2. The cyclic metal palladium dimer according to claim 1, having a structure shown in any one of (I-1), (I-2), (I-3), (II-1), (II-2), (II-3), (III-1), (III-2), and (III-3):

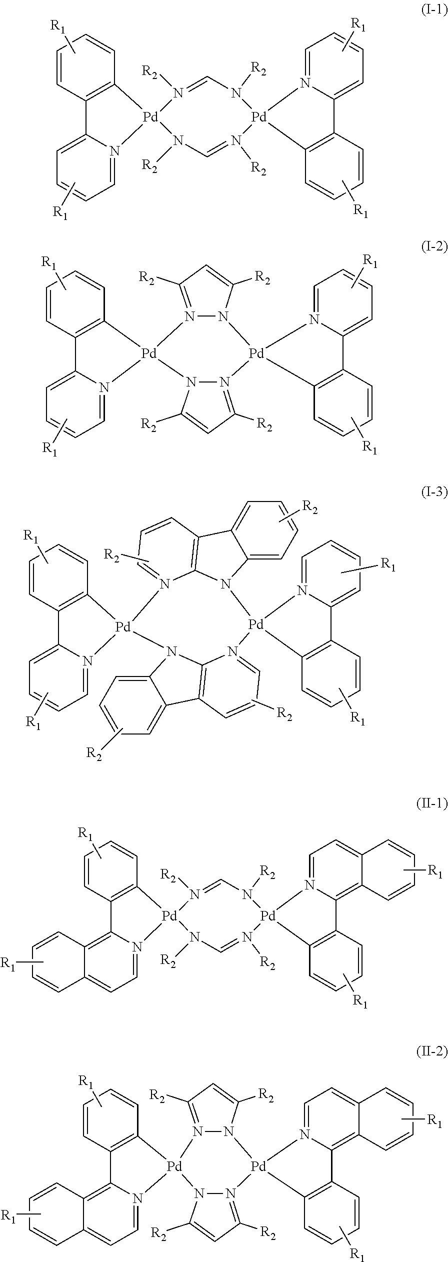

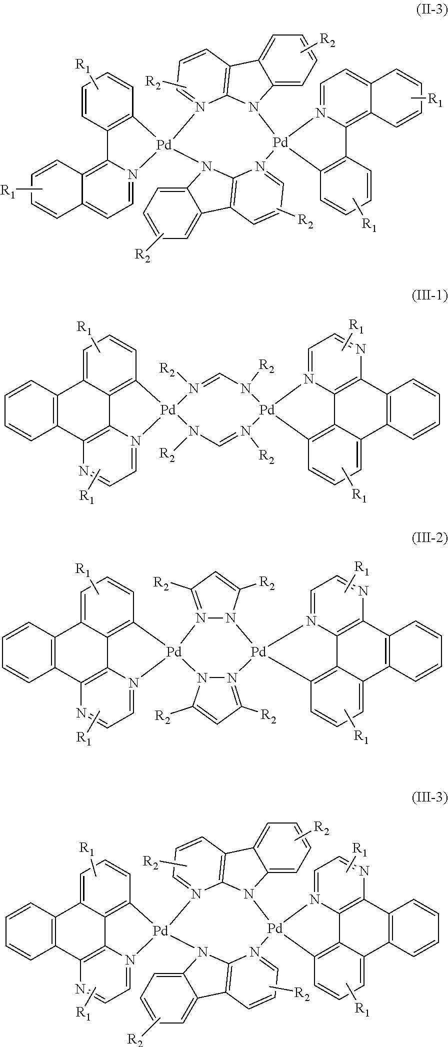

3. The cyclic metal palladium dimer according to claim 1, having a structure shown in any one of C₁ to C₁₃:

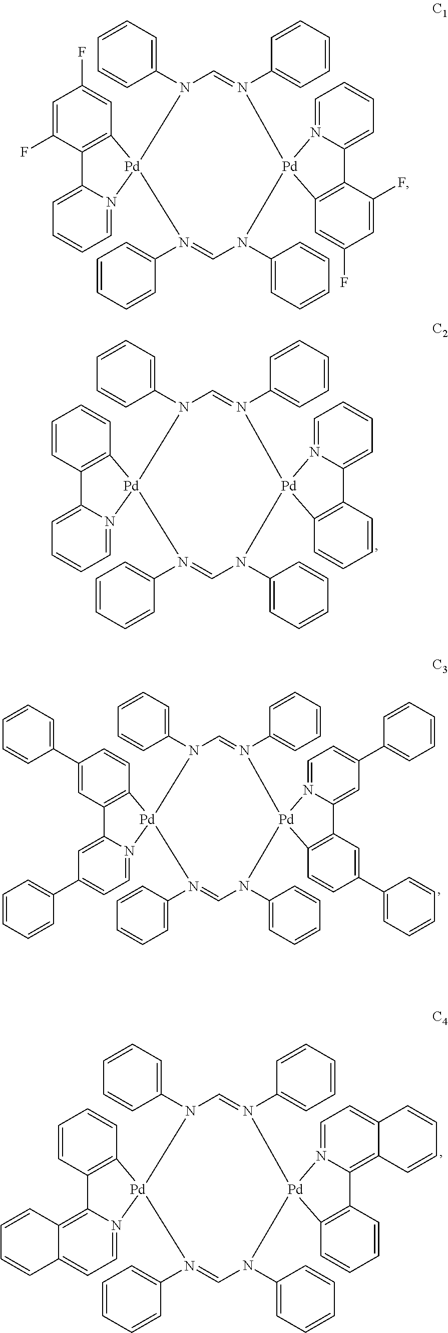

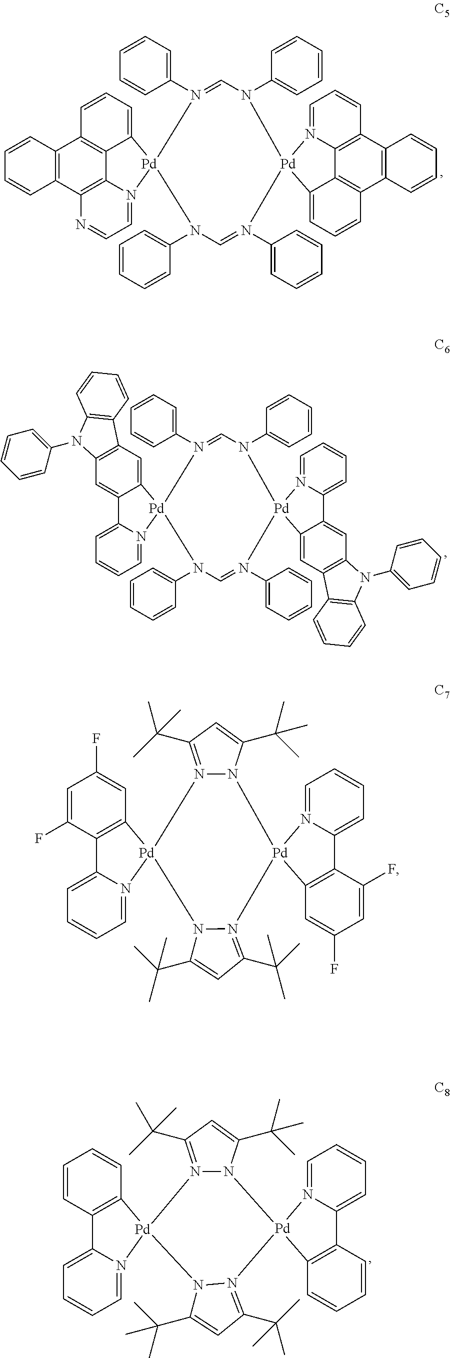

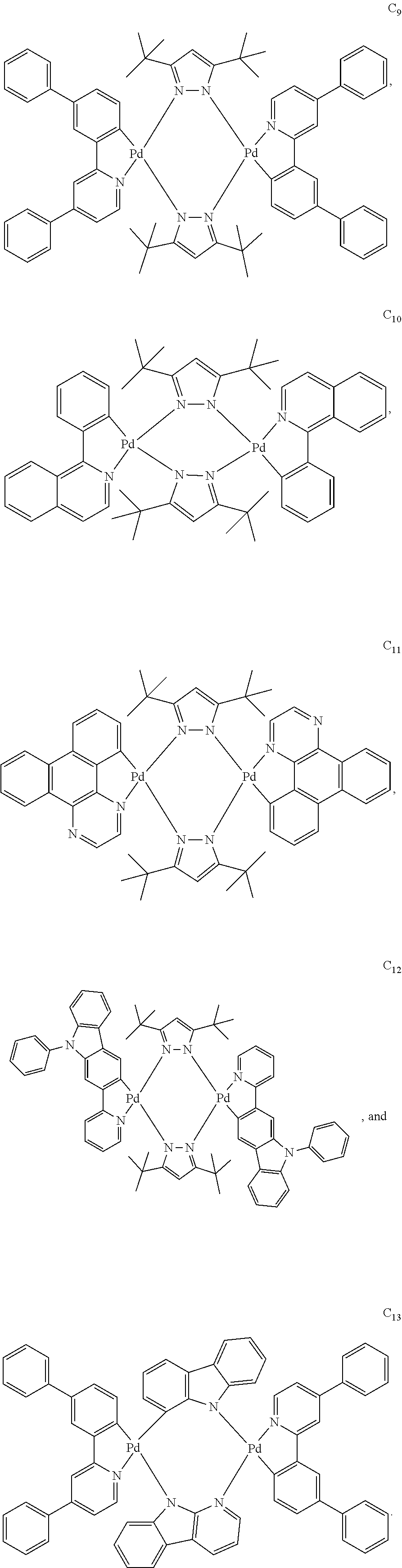

4. A preparation method of the cyclic metal palladium dimer according to claim 1, comprising the following steps: mixing a cyclic metal palladium carboxylic acid dimer, 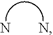
a first polar solvent, and an alkaline reagent to allow a displacement reaction to obtain the cyclic metal palladium dimer; wherein
the cyclic metal palladium carboxylic acid dimer has a structure shown in any one of (XIV) to (XIX): 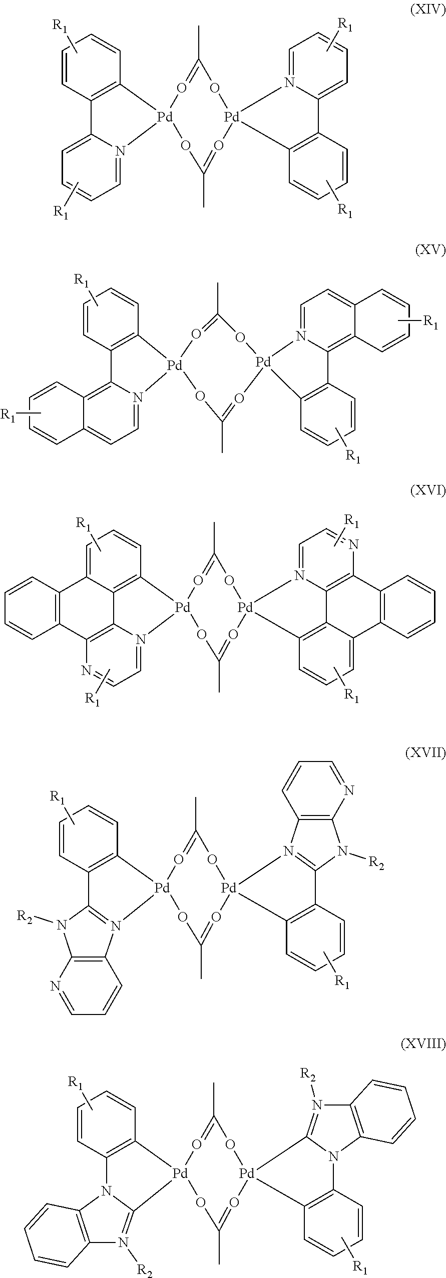 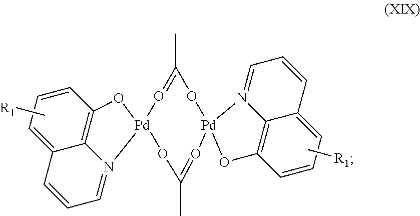
and
the 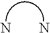
is selected from the group consisting of

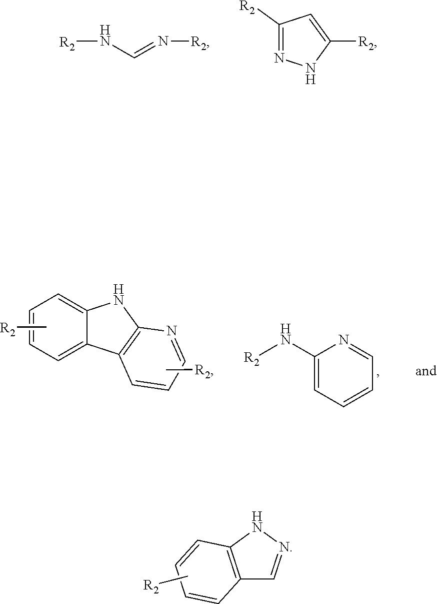

5. The preparation method according to claim 4, wherein the cyclic metal palladium carboxylic acid dimer and the 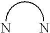
are at a molar ratio of 1:(2.1-5).

6. The preparation method according to claim 4, wherein the cyclic metal palladium carboxylic acid dimer and the alkaline reagent are at a molar ratio of 1:(2-4).

7. The preparation method according to claim 4, wherein the alkaline reagent is an alkali metal alkoxide.

8. The preparation method according to claim 6, wherein the alkaline reagent is an alkali metal alkoxide.

9. The preparation method according to claim 4, wherein when the 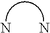
is the 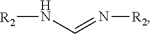
the first polar solvent is acetone;
when the 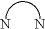
is the 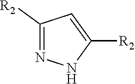
or the 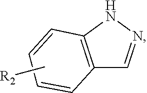
the first polar solvent is selected from the group consisting of acetone and methanol; and
when the 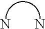
is the 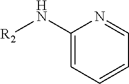
or the 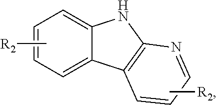
the first polar solvent is selected from the group consisting of acetone, methanol, and tetrahydrofuran.

10. The preparation method according to claim 4, wherein when the 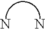
is the 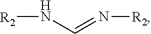
the displacement reaction is conducted in the dark for 5 h to 10 h; when the 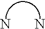
is the 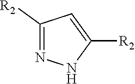
or the 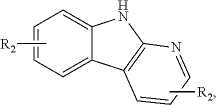
the displacement reaction is conducted at 45° C. to 70° C. for 3 h to 6 h; and when the 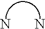
is the 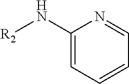
or the 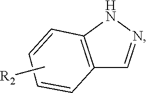
the displacement reaction is conducted at 45° C. to 80° C. for 5 h to 10 h.

11. The preparation method according to claim 4, wherein the cyclic metal palladium dimer prepared by the preparation method is used in an emission layer of an organic light-emitting diode (OLED).
